(19) United States
(12) Patent Application Publication
(10) Pub. No.: US 2025/0059474 A1
(43) Pub. Date: Feb. 20, 2025

(54) Liquid formulation comprising an alcohol and highly water soluble manganese complex salt catalyst, bleaching formulation and cleaning agent comprising the same

(71) Applicant: Catexel GmbH, Wiesbaden (DE)

(72) Inventors: Ronald Hage, Leiden (NL); Yfranka Roelofsen, Hazerswoude-Rijndijk (NL)

(21) Appl. No.: 18/805,944

(22) Filed: Aug. 15, 2024

(30) Foreign Application Priority Data
Aug. 19, 2023 (EP) 23000115.8

(51) Int. Cl. C11D 3/39; C11D 3/04; C11D 3/16; C11D 3/20; C11D 3/43

(52) U.S. Cl. CPC C11D 3/3927; C11D 3/042; C11D 3/168; C11D 3/2068; C11D 3/2086; C11D 3/393; C11D 3/3947; C11D 3/43

(57) ABSTRACT

Disclosed is a liquid composition containing a solvent selected from the group consisting of mono aliphatic alcohols having two to six carbon atoms, mono-, di-, tri- or tetraalkylene glycols having two, three or four carbon atoms in the alkylene moiety, cyclohexanol, benzyl alcohol or glycerol, whereby each OH group may be optionally, and independently, substituted by a OR group, whereby R is alkyl with 1 to 4 carbon atoms, and whereby the solvent optionally contains 0.01-10 wt-% of an inorganic or organic acid, and dissolved therein a mononuclear or dinuclear Mn(III) and/or Mn(IV) complex salt having a selected non-coordinating counter ion, having a water-solubility of at least 30 g/L at 20° C., and wherein the mononuclear or dinuclear Mn(III) and/or Mn(IV) complex comprises at least one cyclic triamine ligand

The liquid compositions and formulations comprising it are suitable for use in catalysing oxidation, for example as a component of a dishwasher bleaching composition. The invention further relates to cleaning agents comprising the liquid compositions described herein.

### CLAIM FOR PRIORITY

This application is a national phase application of European Patent Application 23000115.8, filed Aug. 19, 2023, the priority of which is hereby claimed and its disclosure incorporated by reference herein in its entirety.

### FIELD OF THE INVENTION

The present invention concerns liquid compositions that comprise a selected non-aqueous solvent and a selected water-soluble manganese complex salt.

The invention also concerns bleaching formulations comprising said liquid compositions and a peroxy compound or a precursor thereof. The liquid compositions and formulations comprising said compositions are suitable for use in catalysing oxidation or bleaching, for example as a component of an automatic dishwasher (ADW) bleaching composition.

### BACKGROUND

Manganese catalysts based on triazacyclononane ligands are known to be active catalysts in the bleaching of stains in laundry detergent products and in dishwash products and for treatment of cellulosic substrates in e.g. wood-pulp or raw cotton (see for example EP 0 458 397 A2 (Unilever NV and Unilever plc) and WO 2006/125517 A1 (Unilever plc et al.).

Since these catalysts are very effective, only small amounts of them need to be used in bleaching detergent or dishwash formulations, often at levels less than 0.1 wt % in the detergent or dishwasher formulation. A difficulty arising from the use of such low dosing is achieving accurate dosing of the catalyst and homogeneous distribution throughout the formulation. When distribution of the catalyst is heterogeneous in a formulation, the use of such detergent formulations in a washing machine or in handwashing can lead to underdosing (i.e. giving a poorer bleaching performance) or overdosing of the catalyst (i.e. giving rise to excessive hydrogen peroxide decomposition and possibly brown spotting). A well-known approach to circumvent this potential problem is the inclusion of the solid catalyst on a solid support in bleaching formulations or as an alternative to use a solution of the catalyst.

Currently, only the dinuclear tri-μ-oxo bridged manganese (IV) complex of the ligand 1,4,7-trimethyl-1,4,7-triazacyclononane-bis-hexafluorophosphate (hereinafter MnTACN-PF₆)-catalyst is used in the granules (see for example WO2018/210442, Weylchem Wiesbaden GmbH). Recently, also a patent application was published on granules containing highly water-soluble MnTACN catalysts (compare WO 2022/058039 A1, Weylchem Performance Products GmbH).

WO 2022/189535 A1 (Reckitt Benckiser Finish B.V.) discloses a liquid detergent composition comprising manganese 1,4,7-triazacyclononane (MnTACN) and deriatives thereof, a selected hydrotrope and a non-ionic sufactant. The composition is contained in a water-soluble film. The composition may additionally contain an organic solvent, such as dipropylene glycol. The claimed liquid composition is stable, is compatible with polyvinyl alcohol (PVOH) and overcomes current stability and aesthetic limitations of known MnTACN-containing compositions. It was found that the claimed compositions are able of dissolving the MnTACN resulting in transparent liquids while remaining suitable for use with PVOH containers. The liquid composition is recommended for ADW formulations. In this document no anions of the MnTACN-complexes are disclosed. Moreover, an essential part of the composition is the presence of a hydrotrope and of a nonionic surfactant. According to this reference inclusion of a non-ionic surfactant and a hydrotrope to a solvent, such as dipropylene glycol is essential for dissolution of the manganese complex salt. This document does not suggest to provide a liquid composition by omitting the non-ionic surfactant and the hydrotope and by using a selected solvent and a Mn-complex with a selected counter-ion.

US 2012/053109 A1 discloses a stable liquid bleach composition comprising a peroxy component, such as H₂O₂, a polyol, such as glycerin, water and a metal-containing bleach catalyst. Besides a peroxy compound the formulation contains a significant amount of water. In this document many different types of metal-containing bleach catalysts were mentioned. But in the examples only one Mn-complex was disclosed which does not contain any counterion. There is no guidance in this document to use metal-containing bleach catalysts with selected counterions resulting in a high solubility of these catalysts. This document does not suggest to provide a liquid composition by omitting the peroxide and the water and by using a selected solvent and a Mn-complex with a selected counter-ion.

WO 2022/106276 A1 (Reckitt Benckiser Finish B.V.) discloses a liquid detergent composition for ADW formulations comprising MnTACN and deriatives thereof and a polar solvent. The composition is contained in a water-soluble film and preferably contains an aprotic polar solvent. A wide variety of such solvents is listed, such as propylene carbonate, acetonitrile, dimethyl sulfoxide, ethylene carbonate, N-methylpyrrolidone, sulfolane, nitromethane and

N-acetyl piperidine. According to the disclosure the liquid composition is stable, is compatible with PVOH and overcomes current stability and aesthetic limitations of known MnTACN-containing compositions. In this document no anions of the MnTACN-complexes are disclosed.

In most tablets for ADW cleaning, the bleaching catalyst is included as a solid granule at the desired dosage. Currently, only the MnTACN-PF₆ catalyst in the granules is used in ADW tablets.

Some ADW tablets contain also compartments with liquids which often contain a dye as a consumer cue. It is of interest to be able to include a manganese complex, such as MnTACN in such compartments with liquids to be able to remove the need to include solid granules comprising said manganese complex in the solid part of the formulation, leading to further compaction of the automatic dishwash formulation.

Experiments have shown that it is difficult to dissolve MnTACN-PF₆ catalyst in many non-aqueous solvents. Non-aqueous solvents which may be used are DMF or CH₃CN. But these appear to be harmful and should be avoided in ADW formulations meant for domestic usage. Manganese complexes with other anions, that show a high degree of water solubility, might have a wider solubility profile than the PF₆ salt. However, these compounds are obtained by evaporating the aqueous/ethanol solvent mixture or pure aqueous solvent used in the synthesis of these compounds (see for example EP2753627 B1 (Catexel Technologies Ltd.)). Therefore, all impurities originating from the synthesis of these compounds, if present, remain in the dried material, which may lead to further instability (as explained in WO 2006/125517 A1, Unilever PLC and Hindustan Lever Ltd.). So whilst good solubility may be more feasible, high storage stability might become a much bigger issue, than would be expected for the MnTACN-PF₆ catalyst, that is obtained from the same aqueous or aqueous/ethanol mixtures as mentioned before, but has been additionally been precipitated/crystallised in the synthesis process (leading to removal of impurities, if present originally).

While the art of bleaching formulations is continuously progressing, there remains a need of developing further dosage forms of bleaching catalysts that show good storage stability and high bleaching activity. There is especially a need for liquid compositions which can be manufactured by simple processes. The present invention is intended to address these needs.

### SUMMARY OF THE INVENTION

We have surprisingly found that selected manganese complexes can be dissolved and kept stable in selected solvents, including those that also contain minor quantities of an acid. It was found that these liquid compositions also give stability with PVOH which is typically used as a film material for the compartment housing this liquid composition. It has been found that these liquid compositions are suitable for ADW formulations with a liquid compartment.

Viewed from a first aspect, therefore, the invention provides a liquid composition comprising a solvent selected from the group consisting of mono aliphatic alcohols having two to six carbon atoms, mono-, di-, tri- or tetraalkylene glycols having two, three or four carbon atoms in the alkylene moiety, cyclohexanol, benzyl alcohol and/or glycerol, whereby each OH group is selected from the group of, or may be optionally, and independently, substituted by a OR group, whereby R is alkyl with 1 to 4 carbon atoms, and whereby the solvent optionally contains 0.01-10 wt-% of an inorganic or organic acid, and dissolved therein a mononuclear or dinuclear Mn(III) and/or Mn(IV) complex salt having a non-coordinating counter ion and having a water-solubility of at least 30 g/L at 20° C., and wherein the mononuclear or dinuclear Mn(III) and/or Mn(IV) complex comprises at least one ligand of formula (I)

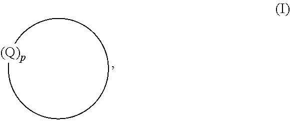

wherein:

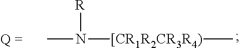

p is 3;
R is independently selected from the group consisting of hydrogen, C₁-C₂₄alkyl, CH₂CH₂OH and CH₂COOH; or one R is linked to the nitrogen atom of another Q of another ring of formula (I) via a C₂-C₆ alkylene bridge, a C₆-C₁₀ arylene bridge or a bridge comprising one or two C₁-C₃ alkylene units and one C₆-C₁₀ arylene unit, which bridge may be optionally substituted one or more times with independently selected C₁-C₂₄ alkyl groups; and
R₁, R₂, R₃, and R₄ are independently selected from H, C₁-C₄alkyl and C₁-C₄-alkylhydroxy.

Ligand of formula (I) is preferably a monocyclic triamine or preferably two monocyclic triamines are linked via a divalent organic bridge group as defined above.

Most preferred the ligand is one ring of formula (I) or two rings of formula (I) linked via an organic divalent group R

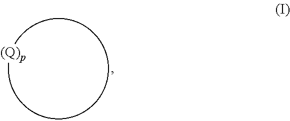

wherein:

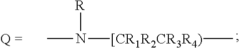

p is 3;
R is independently selected from the group consisting of hydrogen, C₁-C₂₄alkyl, CH₂CH₂OH and CH₂COOH; or one R is linked as a divalent group to the nitrogen atom of another Q of another ring of formula (I), wherein R is selected from a C₂-C₆ alkylene bridge, a C₆-C₁₀ arylene bridge or a bridge comprising one or two C₁-C₃ alkylene units and one C₆-C₁₀ arylene unit, which bridge may be optionally substituted one or more times with independently selected C₁-C₂₄ alkyl groups;
R₁, R₂, R₃, and R₄ are independently selected from H, C₁-C₄alkyl and C₁-C₄-alkylhydroxy.

Viewed from a second aspect, the invention provides a bleaching formulation comprising a liquid composition according to the first aspect of the invention.

Viewed from a third aspect, the invention provides a cleaning agent comprising a liquid composition according to the first aspect of the invention or comprising a bleaching formulation according to the second aspect of the invention.

Further aspects and embodiments of the present invention will be evident from the discussion that follows below.

### DETAILED DESCRIPTION

As summarised above, the present invention is based, in part, on the finding that selected manganese complexes are soluble in selected solvents resulting in stable liquid compositions. Said liquid compositions are coloured due to the inclusion of the manganese complex, exhibit high bleaching activity in bleaching formulations comprising a peroxy compound and exhibit high stability upon storage.

The liquid composition of the first aspect of the invention comprises a solvent selected from the group consisting of mono aliphatic alcohols having two to six carbon atoms, mono-, di-, tri- or tetraalkylene glycols having two, three or four carbon atoms in the alkylene moiety, cyclohexanol, benzyl alcohol and/or glycerol, whereby each OH group may be optionally, and independently, substituted by a OR group, whereby R is alkyl with 1 to 4 carbon atoms, and whereby the solvent optionally contains 0.01-10 wt-% of an inorganic or organic acid, and dissolved therein a mononuclear or dinuclear Mn(III) and/or Mn(IV) complex salt having a non-coordinating counter ion selected from the group consisting of halides (fluorides, chlorides, bromides or iodides), nitrate, nitrite, thiocyanate, cyanate cyanide, sulfate, hydrogen sulfate, sulfate monoester, sulfonates, monocarboxylates, dicarboxylates and dicarboxylate monoesters, and having a water-solubility of at least 30 g/L at 20° C., and wherein the mononuclear or dinuclear Mn(III) and/or Mn(IV) complex comprises at least one ligand of formula (I) as disclosed above.

The term “water-soluble” when used in this description is meant to describe a compound which is soluble in water of 20° C. at a concentration of at least 30 g/L, preferably more than 50 g/L, more preferred more than 100 g/L and most preferred more than 200 g/L.

The term “liquid composition” when used in this description is meant to describe a composition that is in the liquid state at 25° C.

The nature of the non-coordinating counter ion of the manganese complex is an essential feature of the invention. Non-coordinating counter ions are anions selected from the group consisting of halides, nitrate, nitrite, thiocyanate, cyanate cyanide, sulfate, hydrogen sulfate, sulfate monoester, sulfonates, monocarboxylates, dicarboxylates and dicarboxylate monoesters. Preferred non-coordinating counter ions are selected from Cl⁻, Br⁻, I⁻, NO₃⁻, ClO₄⁻, OCN⁻, SCN⁻, SO₄²⁻, R′SO₄⁻, R′COO⁻, R″ oxalate⁻, oxalate²⁻⁻CF₃SO₃⁻ and R′SO₃⁻, whereby R′ is selected from hydrogen, C₁-C₄ alkyl and phenyl or C₁-C₄-alkyl substituted phenyl, preferably methyl substituted phenyl, whereby R″ is selected from H, Na, K and Li.

R″ oxalate⁻ is a mono-charged counterion, whereby R″ can be hydrogen, i.e. HOOC—COO (hydrogen oxalate), or an alkali metal ion selected from Li⁺, Na⁺ and K⁺. In case R″ oxalate⁻ is present, there will be equal number of positive charges in the manganese complex.

Oxalate may also be present as its dianion, which is (COO)₂²⁻. There will be then two or more positive charges present in the manganese complex or two or more manganese complexes of charge +1.

The dianionic oxalate is denoted as oxalate²⁻ when present as counter ion of the Manganese complexes used in this invention.

Hydrogen oxalate is the most typical oxalate salt used as counter ion for the Manganese complexes used in this invention.

Similarly, the sulfate di-anion is denoted as SO₄²⁻, for the same reasons as outlined for oxalate di-anion as outlined above.

Often, the counter ion will be selected from Cl⁻, NO₃⁻, hydrogen oxalate, HSO₄⁻, SO₄²⁻, R′COO⁻ and R′SO₃⁻, whereby R′ is selected from alkyl and aryl, preferably from methyl, phenyl, 4-methylphenyl, 4-ethylphenyl, and 4-isopropylphenyl.

More often, the counter ions will be selected from the group consisting of Cl⁻, SO₄²⁻, NO₃⁻, acetate, benzoate, and toluene sulfonate.

Particularly often, the counter ions will be selected from the group consisting of SO₄²⁻ and NO₃⁻, most preferred is NO₃⁻.

According to particular embodiments, each R of the ring of formula (I) is independently selected from the group consisting of hydrogen, C₁-C₂₄alkyl, CH₂CH₂OH and CH₂COOH; or one R is linked to the nitrogen atom of another Q of another ring of formula (I) via an ethylene or a propylene bridge.

According to other embodiments, each R is independently selected from the group consisting of hydrogen, C₁-C₆-alkyl, CH₂CH₂OH and CH₂COOH; or one R is linked to the nitrogen atom of another Q of another ring of formula (I) via an ethylene or a propylene bridge.

According to other preferred embodiments, each R is independently selected from CH₃, C₂H₅, CH₂CH₂OH and CH₂COOH.

Where one R is linked to the nitrogen atom of another Q of another ring of formula (I), this is typically via an ethylene bridge. In such embodiments, the other R groups, including those in the other ring of formula (I), are the same, typically C₁-C₆-alkyl, in particular methyl.

According to further preferred embodiments, R₁, R₂, R₃, and R₄ are independently selected from hydrogen and methyl, in particular embodiments in which each of R₁, R₂, R₃, and R₄ is hydrogen.

When a compound of formula (I) comprises one group R linked to the nitrogen atom (i.e. N) of another Q of another ring of formula (I) via a bridge, it will be understood that such compounds of formula (I) in particular embodiments comprising an ethylene bridge may alternatively be represented by the following structure:

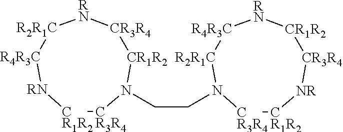

wherein R, R₁, R₂, R₃, and R₄ are as herein defined, including the various specific embodiments set out.

Bridge linking two Q moieties is preferably a C₂-C₆ alkylene bridge, linking two monocyclic polyamines of formula (I). Where the bridge is a C₆-C₁₀ arylene bridge, this may be, for example, phenylene or the corresponding arylene formed by abstraction of two hydrogen atoms from naphthalene.

Examples of preferred triamine ligands are 1,4,7-triazacyclononanes, 1,4,7-triaza-cyclododecanes, 1,4,8-triazacyclododecanes, 1,4,7-trimethyl-1,4,7-triazacyclo-nonanes and 1,4,7-trimethyl-1,4,7-triazacyclododecanes. At the nitrogen atom and/or at the CH-group these compounds can carry further substituents.

Preferred are the following cyclic polyamines: 1,4,7-triazacyclononane (TACN), 1,4,7-trimethyl-1,4,7-triazacyclononane (1,4,7-Me₃TACN), 2-methyl-1,4,7-triaza-cyclononane (2-MeTACN), 1,4-dimethyl-1,4,7-triazacyclononane, 1,2,4,7-tetra-methyl-1,4,7-triaza-cyclononane (1,2,4,7-Me₄TACN), 1,2,2,4,7-pentamethyl-1,4,7-triazacyclononane (1,2,2,4,7-Me₃TACN), 2-benzyl-1,4,7-trimethyl-1,4,7-triazacyclononane, and 2-decyl-1,4,7-trimethyl-1,4,7-triazacyclononane.

These cyclic triamines can be synthesized in a manner as described, for example, by K. Wieghardt et al. in Inorganic Chemistry 1982, 21, 3086 ff. or in “Macrocyclic Chemistry” of B. Dietrich, P. Viout, J.-M. Lehn, Weinheim 1993.

According to particular embodiments of the invention, the ligand of formula (I) is 1,4,7-trimethyl-1,4,7-triazacyclononane (Me₃-TACN) or is 1,2-bis(4,7-dimethyl-1,4,7-triazacyclonon-1-yl)-ethane (Me₄-DTNE). According to still more particular embodiments of the invention, the compound of formula (I) is Me₃-TACN.

Generally, the liquid compositions comprise between 0.05 and 10 wt-% of the manganese complex salt. Still more preferred, the liquid compositions comprise between 0.1 and 5 wt-% of the manganese complex salt.

The solvent used in the liquid compositions of the invention is selected from the group consisting of mono aliphatic alcohols having two to six carbon atoms, mono-, di-, tri- or tetraalkylene glycols having two, three or four carbon atoms in the alkylene moiety, cyclohexanol, benzyl alcohol and/or glycerol. One or more hydroxyl groups of the alcohols may be etherified with an alkanol having one to four carbon atoms. This results in a substitution of the respective OH group by a OR group, whereby R is alkyl with 1 to 4 carbon atoms.

Examples of mono aliphatic alcohols having two to six carbon atoms are ethanol, 1- or 2-propanol, and 1-, 2-, or 3-butanol.

Examples of mono-, di-, tri- or tetraalkylene glycols are ethylene glycol, propylene glycol and butylene glycol and their di-, tri- and tetraalkylene glycol homologues.

Preferred are the alkylene glycols and the respective mono- or dimethyl ethers, most preferred the alkylene glycols having three or four carbon atoms in the alkylene moiety.

Also preferred are the di-, tri- or tetraalkylene glycols and the respective mono- or dimethyl ethers, most preferred the di-tri- or tetraalkylene glycols having three or four carbon atoms in the alkylene moiety.

The solvent may optionally contain 0.01-10 wt-% of an inorganic or organic acid. This improves still more the stability of the liquid composition.

Inorganic acids may be mineral acids, such as hydrochloric acid, sulfuric acid, phosphorous acid, perchloric acid and nitric acid. Preferred are sulfuric acid and nitric acid.

Organic acids may be mono- or dicarboxylic acids or monosulfonic acids. Examples are formic acid, acetic acid, propionic acid, butyric acid, maleic acid, oxalic acid, citric acid and ascorbic acid, preferred is citric acid.

The liquid composition of the invention may contain, besides the manganese complex salt and the solvent(s) mentioned above minor portions, such as 5% by weight or less, preferably 3% by weight or less of additional polar solvents, for example water.

Examples of polar solvents are N-acetylcaprolactam, propylene carbonate, valerolactone, acetonitrile, ε-caprolactone, ε-caprolactam, dimethylsulphoxide, ethylene carbonate, γ-butyrolactone, N-methylpyrrolidone, methyl sulpholane, sulpholane, 2,3-butylene carbonate, nitromethane, 2-pyrrolidone, butadiene sulfone, cyclobutanone, cyclopentanone, ethylene sulphite, glycerol carbonate acetate, N-acetyl piperidine, and/or N-acetyl pyrrolidone.

The preferred polar solvent content of the liquid composition of the invention is below 3% by weight. Most preferred the liquid composition of the invention is free of polar solvents, preferably water-free.

The liquid composition of the invention may contain, besides the manganese complex salt, the alkylene glycol solvent and optionally the additional polar solvent and/or acid minor portions, such as 20% by weight or less, preferably 10% by weight or less, and more preferred 5% by weight or less of additional ingredients.

Examples of additional ingredients are surfactants, preferably nonionic surfactants, hydrotopes, redox-active substances, paraffin oil, benzotriazoles, dyes and/or material care agents.

Examples of material care agents are silver or copper protection agent(s). Preferred silver/copper protection agents are benzotriazole (BTA) or bis-benzotriazole and substituted derivatives thereof. A preferred BTA is tolyltriazole (TTA).

Without wishing to be bound by theory, it is believed that the addition of a nitrogen donor ligand, such as BTA, helps to stabilise the manganese complex salt against degradation in solution.

In a preferred embodiment, the liquid composition comprises a manganese complex salt, wherein the ligand is 1,4,7-trimethyl-1,4,7-triazacyclononane (Me₃-TACN) or 1,2-bis(4,7-dimethyl-1,4,7-triazacyclonan-1-yl) ethane (Me₄-DTNE).

In another preferred embodiment, the liquid composition comprises a manganese complex salt, wherein the non-coordinating counter ion is an anion selected from the group consisting of Cl⁻, Br⁻, I⁻, NO₃⁻, ClO₄⁻, OCN⁻, SCN⁻, SO₄²⁻, R′SO₄⁻, R′COO⁻, R″ oxalate⁻, oxalate²⁻, CF₃SO₃⁻ and R′SO₃⁻, whereby R′ is selected from hydrogen, C₁-C₄ alkyl and optionally methyl substituted phenyl, whereby R″ is selected from H, Na, K and Li. R″ oxalate⁻ is a mono-charged counterion, whereby R″ can be hydrogen, i.e. HOOC—COO⁻ (hydrogen oxalate), or an alkali metal ion selected from Li⁺, Na⁺ and K⁺.

In a more preferred embodiment, the liquid composition comprises a non-coordinating counter ion that is selected from the group consisting of NO₃⁻, SO₄²⁻; HSO₄⁻, Cl⁻, acetate, tosylate or benzoate.

In another preferred embodiment, the liquid composition comprises a ion-containing bleaching catalyst that is selected from the group consisting of [Mn^{IV}₂(μ-O)₃(Me₃TACN)₂]SO₄, [Mn^{IV}₂(μ-O)₃(Me₃TACN)₂](NO₃)₂, [Mn^{IV}₂(μ-O)₃(Me₃TACN)₂](tosylate)₂, [Mn^{III}Mn^{IV}(μ-O)₂(μ-CH₃COO)(Me₄DTNE)]—SO₄, [Mn^{III}Mn^{IV}(μ-O)₂(μ-CH₃COO)(Me₄DTNE)](NO₃)₂, [Mn^{III}Mn^{IV}(μ-O)₂(μ-CH₃COO) (Me₄DTNE)]Cl₂ and [Mn^{IV}₂(μ-O)₃(Me₃TACN)₂]Cl₂, more preferred selected from the group consisting of [Mn^{IV}₂(μ-O)₃(Me₃TACN)₂]SO₄, [Mn^{IV}₂(μ-O)₃(Me₃TACN)₂](NO₃)₂ and [Mn^{IV}₂(μ-O)₃(Me₃TACN)₂](tosylate)₂.

In a preferred composition the solvent is selected from the group consisting of mono aliphatic alcohols having three to six carbon atoms, mono alkylene glycols having three or four carbon atoms in the alkylene moiety, di-, tri- or tetraalkylene glycols having two, three or four carbon atoms in the alkylene moiety, cyclohexanol, benzyl alcohol and/or glycerol, whereby each OH group may be optionally, and independently, substituted by a OR group, whereby R is alkyl with 1 to 4 carbon atoms.

In a more preferred composition the solvent is selected from the group consisting of mono alkylene glycols having three or four carbon atoms in the alkylene moiety, and/or di-, tri- or tetraalkylene glycols having two, three or four carbon atoms in the alkylene moiety, whereby each glycol OH group may be optionally, and independently, substituted by a OR group, whereby R is alkyl with 1 to 4 carbon atoms, with the proviso that the solvent is not ethylene glycol.

In still another preferred embodiment, the liquid composition comprises a solvent that is selected from propylene glycol, butylene glycol, di-ethylene glycol, di-propylene glycol, di-propylene glycol, di-butylene glycol, tri-ethylene glycol, tri-propylene glycol, tri-butylene glycol, tetra-ethylene glycol, whereby each glycol OH group may be optionally, and independently, substituted by a OR group, whereby R is alkyl with 1 to 4 carbon atoms.

In a still more preferred embodiment, the liquid composition comprises a solvent whereby R is methyl.

Very preferred solvents are those, wherein propylene is selected from 1,2-propylene or 1,3-propylene and wherein butylene is selected from 1,2-butylene, 1,3-butylene or 1,4-butylene.

Still more preferred solvents are those that are selected from the group consisting of propylene glycol, diethylene glycol, triethylene glycol, dipropylene glycol, tripropylene glycol, propylene glycol monomethyl ether, and dipropylene glycol methyl ether.

Most preferred solvents are selected from propylene glycol, propylene glycol monomethyl ether, and dipropylene glycol methyl ether.

Most preferred acids are selected from the group consisting of sulfuric acid, nitric acid and citric acid.

In a very preferred embodiment of the liquid composition of the invention the amount of mononuclear or dinuclear Mn(III) and/or Mn(IV) complex is between 0.1 and 5 wt-% referring to the total amount of complex and solvent.

The liquid composition may also comprise of a bleaching activator As bleaching activators, the compositions of the invention can contain compounds generally known from the prior art. These are preferably multiple acylated alkylene diamines, in particular tetraacetylethylene diamine (TAED), acylated triazine derivatives, in particular 1,5-diacetyl-2,4-dioxohexahydro-1,3,5-triazine (DADHT), acylated glycolurils, in particular tetraacetylglycoluril (TAGU), glyceroltriacetate (triacetin), N-acylimides, in particular N-nonanoyl succinimide (NOSI), acylated phenolic sulfonates, in particular n-nonanoyloxi- or n-lauroyloxibenzenesulfonate (NOBS or LOBS), acylated phenolic carboxylic acids, in particular nonanoyloxi- or decanoyloxibenzoic acid (NOBA or DOBA, respectively), carboxylic acid anhydrides, in particular phthalic acid anhydride, acylated multivalent alcohols, preferably triacetine, ethyleneglycol diacetate and 2,5-diacetoxy-2,5-dihydrofurane as well as acetylated sorbitol and mannitol or their mixtures, respectively (SORMAN), acylated sugar derivatives, preferably pentaacetylglucose (PAG), pentaacetylfructose, tetraacetylxylose and octaacetyllactose as well as acetylated and optionally N-alkylated glucamine and gluconolactone, and/or N-acylated lactams, for example N-benzoyl-caprolactam. Hydrophilic substituted acylacetales and acyllactames can also preferably be used. In addition, nitrile derivatives such as n-methyl-morpholinium acetonitrile-methyl sulfate (MMA) or cyanomorpholine (MOR) can be used as bleaching activators. Combinations of bleaching activators can also be used.

Suitably the liquid composition may comprise TAED, NOBS, triacetin, and DOBA. More suitably the liquid composition may comprise TAED.

In an embodiment, the liquid composition comprises of 0.5-30 wt-% of the bleaching activator. Suitably the liquid composition comprises of 1-20 wt-% of the bleaching activator. Preferred is a liquid composition without any bleaching activator.

The production of the liquid compositions according to the invention can be carried out according to methods known per se.

In a first preferred process variant, dissolution of the solid components in the solvent takes place in a mixing apparatus. The components are processed in usual mixing devices operating batch-by-batch or continuously, which are usually equipped with rotating mixing organs. When mixing, all mixing variants are conceivable, which ensure a sufficient mixing the components.

In a preferred embodiment, all components are mixed at the same time. However, multi-stage mixing processes are also conceivable, in which the individual components are entered in the overall mixture individually or together with other additives in different combinations.

The solvent is intensively mixed with powdery active substances and other additives optionally present, resulting in a liquid composition. During the mixing step the content of the mixture can be heated in order to accelerate dissolution of the solid components.

Preferred liquid compositions according to the invention are also characterized by a water content of less than 3% by weight (measured by Karl Fischer), based on the total amount of compositions, especially preferred 0 to 2% by weight. Most preferred the liquid compositions of the invention are water-free or almost water-free, meaning their water-content is below 1% by weight.

As will be appreciated by the person skilled in the art, it may be desirable to subject the liquid compositions according to the first aspect of the invention to further processing, for example to include these compositions in the bleaching formulations or in cleaning formulations, such as ADW formulations. Whilst compositions according to the first aspect of the invention can be included in the bleaching formulations and cleaning formulations as such owing to their excellent storage stability, the formulator may want to combine the bleaching agents or the ingredients of a cleaning formulation with a liquid composition stored in a containment with walls made of water-soluble polymers, such as PVOH.

The liquid compositions according to the first aspect of the invention are of particular use when used in bleaching formulations. The bleach catalyst present in the liquid composition serves to catalyse the oxidising activity of a peroxy compound, which may either be included within a bleaching formulation according to the present invention, or may be generated from such a bleaching formulation in situ.

Where a peroxy compound is present in a bleaching formulation comprising the liquid compositions of the invention this may be, and typically is, a compound which is capable of yielding hydrogen peroxide in aqueous solution. Suitable amounts of peroxy compounds included within the bleaching formulation may be determined by the skilled person although typical quantities will be within the range of 1-35 wt %, for example 5-25 wt %, based on the solids content of the bleaching formulation. One of skill in the art will appreciate that smaller quantities of peroxy compounds may be used where the bleaching formulation comprises a bleaching system (discussed below) comprising a peroxy compound and a so-called bleach precursor.

Suitable hydrogen peroxide sources are well known in the art. Examples include the alkali metal peroxides, organic peroxides such as urea peroxide, and inorganic persalts, such as alkali metal perborates, percarbonates, perphosphates, persilicates, and persulfates. Typical peroxy compounds included within bleaching formulations are persalts, for example optionally hydrated sodium perborate (e.g. sodium perborate monohydrate and sodium perborate tetrahydrate) and sodium percarbonate. According to particular embodiments, the bleaching formulation comprises sodium perborate monohydrate or sodium perborate tetrahydrate. Inclusion of sodium perborate monohydrate is advantageous owing to its high active oxygen content. Use of sodium percarbonate is most advantageous for environmental reasons.

Organic peroxy acids may also serve as the peroxy compound. These may be mono- or diperoxyacids. Typical mono- or diperoxyacids are of the general formula HOO—(C—O)—R—Z, wherein R is an alkylene or substituted alkylene group containing from 1 to about 20 carbon atoms, optionally having an internal amide linkage or a phenylene or substituted phenylene group; and Z is hydrogen, halogen, alkyl, aryl, an imido-aromatic or non-aromatic group, a COOH or (C═O) OOH group or a quaternary ammonium group.

Typical monoperoxy acids include peroxy benzoic acids, peroxy lauric acid, N,N-phtaloylaminoperoxy caproic acid (PAP) and 6-octylamino-6-oxo-peroxyhexanoic acid. Typical diperoxy acids include for example: 1,12-diperoxydodecanoic acid (DPDA) and 1,9-diperoxyazeleic acid.

As well as organic peroxyacids, inorganic peroxyacids are also suitable, for example potassium monopersulfate (MPS).

If organic or inorganic peroxyacids are included within bleaching formulations, the amount of them incorporated in a bleaching formulation will typically be within the range of about 2-10 wt %, for example 4-8 wt %.

The bleaching formulation need not comprise a peroxy compound, however: a bleaching formulation of the invention may instead comprise a bleaching system constituted by components suitable for the generation of hydrogen peroxide in situ, but which are not themselves peroxy compounds.

Often, a bleaching species is generated in situ. For example, organic peroxyacids are often generated in situ, as opposed to being included within the bleaching formulation, peroxyacids themselves tending to be insufficiently stable. For this reason, bleaching formulations often comprise a bleaching system comprising a persalt (e.g. sodium perborate (optionally hydrated) or sodium percarbonate), which yields hydrogen peroxide in water; and a so-called peroxy bleach precursor capable of reacting with the hydrogen peroxide to generate an organic peroxyacid.

Where used, bleach precursor compounds are typically present in the bleaching formulation in an amount of up to 12 wt %, for example from 2-10 wt %, of the composition, based on the solids content of the bleaching formulation.

Peroxy compounds or bleaching systems as described herein can be stabilised within the bleaching formulation by providing them with a protective coating, for example a coating comprising sodium metaborate and sodium silicate.

For automatic dishwash cleaning, corrosion on glassware during the rinsing stages can be suppressed by using glass corrosion inhibitors. These are, for example, crystalline layered silicates and/or zinc salts. Crystalline layered silicates are available for example from WeylChem under the trade name of SKS-6 (δ-Na₂Si₂O₅). Other known crystalline layered silicates are e.g. Na—SKS-1 (Na₂Si₂₂O₄₅·XH₂O, kenyaite), Na—SKS-2 (Na₂Si₁₄O₂₉·xH₂O, magadiite), Na—SKS-3 (Na₂Si₈O₁₇·xH₂O), Na—SKS-4 (Na₂Si₄O₉·xH₂O, makatite), Na—SKS-5 (α—Na₂Si₂O₅), Na—SKS-7 (β-Na₂Si₂O₅, natrosilite), Na—SKS-9 (NaHSi₂O₅·H₂O), Na—SKS-10 (NaHSi₂O₅·3H₂O, kanemite), Na—SKS-11 (t-Na₂Si₂O₅) and Na—SKS-13 (NaHSi₂O₅). An overview of crystalline sheet-silicates is found, for example, in the article published in “Seifen-Öle-Fette-Wachse, volume 116, No. 20/1990”, on pages 805-808.

In a further preferred embodiment of the invention, the cleaning compositions of the present invention, in particular the dishwasher detergents, incorporate the crystalline layered silicate at preferably 0.1 to 20 wt %, more preferably 0.2 to 15 wt % and more preferably 0.4 to 10 wt %, all relative to the overall weight of the composition.

To control glass corrosion, cleaning compositions of the present invention, in particular dishwasher detergents, may incorporate at least one zinc or bismuth salt, preferably selected from the group of organozinc salts, more preferably selected from the group of soluble organozinc salts, yet more preferably selected from the group of soluble zinc salts of monomeric or polymeric organic acids and yet still more preferably selected from the group consisting of zinc acetate, zinc acetylacetonate, zinc benzoate, zinc formate, zinc lactate, zinc gluconate, zinc oxalate, zinc ricinoleate, zinc abietate, zinc valerate and zinc p-toluenesulfonate. Bismuth salts such as, for example, bismuth acetates are employable as an alternative to or in combination with these zinc salts.

Preference in the context of the present invention is given here to cleaning compositions, in particular dishwasher detergents, where the amount of zinc salt, relative to the overall weight of this composition, is from 0.1 to 10 wt %, preferably from 0.2 to 7 wt % and more preferably from 0.4 to 4 wt %, irrespective of which zinc salts are used, specifically irrespective that is as to whether organic or inorganic zinc salts, soluble or insoluble zinc salts or mixtures thereof are used.

Cleaning agents of the invention may also contain silver corrosion inhibitors for silver corrosion control. Preferred silver corrosion inhibitors are organic sulfides such as cystine and cysteine, di- or trihydric phenols, optionally alkyl- or aryl-substituted triazoles such as benzotriazole, isocyanuric acid, salts and/or complexes of titanium, of zirconium, of hafnium, of cobalt or of cerium wherein the metals referred to are present in one of the oxidation states II, III, IV, V or VI, depending on the metal.

According to particular embodiments, bleaching formulations may be used for bleaching and/or modifying (e.g. degrading) polysaccharides (for example cellulose or starch) or polysaccharide-containing (for example cellulose-containing, also referred to herein as cellulosic) substrates. Cellulosic substrates are found widely in domestic, industrial and institutional laundry, wood-pulp, cotton processing industries and the like. For example, raw cotton (gin output) is dark brown in colour owing to the natural pigment in the plant. The cotton and textile industries recognise a need for bleaching cotton prior to its use in textiles and other areas. The object of bleaching such cotton fibres is to remove natural and adventitious impurities with the concurrent production of substantially whiter material.

Irrespective of the nature of the substrate treated in accordance with the method of the fourth aspect of the invention, it is the objective when doing so to effect bleaching, i.e. to remove unwanted chromophores (be they, for example, stains or solids on cloth in laundering or dishwashing applications; residual lignin in wood pulp or polyphenolic materials present in raw cotton and wood pulp and paper) and/or to degrade material, for example starch or polyphenolic materials in dishwashing. According to particular embodiments, therefore, the substrate may be a dirty dish or a polysaccharide- or polysaccharide-containing substrate, for example wherein the polysaccharide is a cellulosic substrate, such as cotton, wood pulp, paper or starch.

The bleaching formulation of the present invention may thus be used in a method of dishwashing. Such a method typically involves cleaning dishes in a mechanical dishwasher, often to remove starch and polyphenolic components from the dishes' surfaces. The term “dishes” herein embraces within its scope cookware as well as plates, crockery and other eating (e.g., cutlery) and serving tableware, for example items made of ceramic, metallic or plastics materials.

Accordingly, embodiments of the fourth aspect of the invention include methods of cleaning dishes in a mechanical dishwasher, which comprise contacting the dishes with water and a bleaching formulation in accordance with the third aspect of the invention.

Although it is to be understood that the invention is not to be considered to be so limited, where a bleaching formulation is intended for use in hard-surface cleaning applications, the bleaching formulation will typically comprise other components well understood by those of normal skill in the art, such as bleach stabilisers (also known as sequestrants), for example organic sequestrants such as aminophosphonate or carboxylate sequestrants; one or more surfactants, for example cationic anionic or non-anionic (amphiphilic) surfactants; as well as other components, including (but not limited to) detergency builders, enzymes and perfuming agents.

A bleaching formulation according to the third aspect of the invention, will contain preferably between 0.1 and 50 wt-% of one or more surfactants. This bleaching formulation may comprise one or more anionic surfactants and one or more non-ionic surfactants. In general the anionic and nonionic surfactants of the surfactant system may be chosen from the surfactants described in “Surfactant Active Agents, Vol 1 by Schwartz & Perry, Interscience 1949, vol 2 by Schwartz, Perry & Berch, Interscience 1958; in the current edition of “Mccutcheon's Emulsifiers and Detergents” published by Manufacturing Confectioners Company; or in Tenside Taschenbuch, H. Stache, Carl Hauser Verlag, 1981. Examples of descriptions of suitable anionic and nonionic surfactants can for example be found in WO 03/072690 A1 (Unilever N. V. et al.), WO 02/068574 A1 (Unilever N. V. et al.) and WO 2012/048951 A1 (Unilever PLC et al.)

Those knowledgeable of bleaching formulations will be familiar with the use of enzymes in this context. Enzymes can provide cleaning performance, fabric care and/or sanitation benefits. Said enzymes include oxidoreductases, transferases, hydrolases, lyases, isomerases and ligases. Members of these enzyme classes are described in Enzyme Nomenclature 1992:

Recommendations of the Nomenclature Committee of the International Union of Biochemistry and Molecular Biology on the Nomenclature and Classification of Enzymes, 1992, ISBN 0-1202271165-3, Academic Press. Detersive enzymes are described in greater detail in for example U.S. Pat. No. 6,579,839 (Price et al.).

Suitable detergency builders as optional ingredients may also be present, for example as described in WO 00/34427 A1. Builders may include aluminosilicates, in particular zeolites, e.g. zeolite A, B, C, X and Y types, as well as zeolite MAP as described in EP 0 384 070 A; and precipitating builders such as sodium carbonate. Such builders are typically present in an amount from about 5 to about 80 wt-%, more preferably from about 10 to 50 wt-%, based on the solids content of the bleaching formulation.

The skilled person will be readily able to formulate a suitable bleaching formulation for use in dishwash cleaning or laundry cleaning in accordance with his normal skill. Likewise, the skilled person will be readily able to formulate bleaching formulations suitable for use in the other applications described herein. Such formulations may, for example, comprise additional metal-ion based bleach catalysts or organic bleach catalysts suitable for catalysing the activity of the peroxy compounds described herein. Non-limiting examples of transition-metal based bleaching catalysts can be found for example in EP 2 228 429 A1 (Unilever PLC and Unilever N. V.), and references cited therein and examples of organic catalysts can be found in WO 2012/071153 A1 (The Procter & Gamble Company).

The invention also relates to a cleaning method said method comprising contacting a substrate to be cleaned with water and a bleaching formulation as defined herein before.

Preferably the cleaning method is a method of cleaning dishes, in particular by using a mechanical dishwasher, the method comprising contacting the dishes to be cleaned with water and the bleaching formulation as defined hereinto before.

The non-limiting examples below more fully illustrate the embodiments of this invention.

### EXPERIMENTAL

### Chemicals Used

Dipropylene glycol was obtained from Sigma Aldrich.

Sulfuric acid (98%) was obtained from Merck.

Nitric acid (65%) was obtained from Merck.

Citric acid was obtained from VWR Chemicals.

Dowanol PM and Dowanol DPM were obtained from Merck. [Mn^{IV}₂(μ-O)₃(Me₃-TACN)₂](PF₆)₂*H₂O (Me₃-TACN=1,4,7-trimethyl-1,4,7-triazacyclononane), abbreviated as MnTACN-PF₆, was obtained as described in EP0458397 B (Unilever NV and Unilever PLC). The solubility in water is 10.8 g/L (20° C.).

[Mn^{IV}₂(μ-O)₃(Me₃-TACN)₂]SO₄*4H₂O, abbreviated as MnTACN-SO₄, was obtained as described in EP2753627B (Catexel Technologies Ltd). The solubility in water at 20° C. was determined to be greater than 735 g/L, which equates to >73.5 wt %.

[Mn^{IV}₂(μ-O)₃(Me₃-TACN)₂](NO₃)₂, abbreviated as MnTACN-NO₃, was obtained in an analogous manner as described in EP2753627B for the MnTACN-SO₄ salt, except that Mn(NO₃)₂ was used as a starting material for the synthesis.

The solubility in water at 20° C. was determined to be greater than 283 g/L, which equates to >28.3 wt %. [Mn^{IV}₂(μ-O)₃(Me₃-TACN)₂]Cl₂*3H₂O, abbreviated as MnTACN-Cl₂ was obtained as described in EP275362B (Catexel Technologies Ltd), and [Mn^{IV}₂(μ-O)₃(Me₃-TACN)₂](tosylate)₂, abbreviated as MnTACN-Ts₂, was obtained as described in WO2011/066934 (Clariant International Ltd.). The solubility of [Mn^{IV}₂(μ-O)₃(Me₃-TACN)₂]Cl₂*3H₂O in water at 20° C. was determined to be greater than 182 g/L, which equates to >18.2 wt %. The solubility of [Mn^{IV}₂(μ-O)₃(Me₃-TACN)₂](tosylate)₂ in water at 20° C. was determined to be greater than 100 g/L, which equates to >10 wt %.

The following experiments show benefits of MnTACN catalysts having a high water solubility versus MnTACN-PF₆.

[Mn^{IV}₂(μ-O)₃(Me₃-TACN)₂](benzoate)₂*4H₂O abbreviated as MnTACN-benzoate, was prepared as described for [Mn^{IV}₂(μ-O)₃(Me₃-TACN)₂]SO₄ in EP2753627B (Catexel Technologies Ltd), except that now together with MnSO₄ 1 mol equivalent of sodium benzoate was added in the complexation step, and after the oxidation/neutralisation step, another 1.5 mol equivalent of sodium benzoate was added. Isolation and work up took place as described in the same patent for example 6—[Mn^{IV}₂(μ-O)₃(Me₃-TACN)₂]SO₄.

The analysis of the product isolated in 80% yield is as follows:

Anal. calcd. for C₃₂H₆₀Mn₂N₆O₁₁: C, 47.17, H, 7.42, N, 10.32; Found: C, 47.27, H, 7.57, N, 11.07%.

IR (KBr pellet): 3458br, 2961w, 2925w, 1595s, 1510vs, 1452m, 1397s, 1051m, 1024w, 1004m, 790m, 705m, 660m, 593m cm⁻¹.

¹H NMR (D₂O, 400 MHz) (ppm): 2.25 (br, 42H, NCH₃+NCH₂), 7.44 (t, J=7.2, 4H, Ph-H), 7.53 (t, J=7.2, 2H, Ph-H), 7.86 (d, J=7.2, 4H, Ph-H).

UV/Vis (ε: M-1.cm-1, in water): 224 nm (40237), 278 nm (21132), 315 nm (13143), 392 nm (1240), 482 nm (510).

The solubility in water at 20° C. of [Mn^{IV}₂(μ-O)₃(Me₃-TACN)₂](benzoate)₂*4H₂O was determined to be greater than 1000 g/L.
A) Tests demonstrating that solvents used in this invention do not interact with PVOH pouches

In small pouches made from a standard PVOH film, different solvents were added (1 mL), the pouch was sealed using a hot plate (150° C.). The pouches containing the solvent were stored for 26 weeks at 40° C. and then for 26 weeks at room temperature. When the pouches did not change appearance or leaked solvent, they were denoted as stable.

The following solvents showed a good stability of the PVOH pouches when containing the solvents listed below
Dipropylene glycol
Dipropylene glycol with 3 wt % H₂SO₄
Dipropylene glycol with 3 wt % HNO₃
Dipropylene glycol with 3 wt % citric acid
Dowanol DPM (dipropylene glycol methyl ether)
Dowanol PM*) (propylene glycol methyl ether) with 3 wt % HNO₃ *) Dowanol PM without acid, or with H₂SO₄ or with citric acid is not stable

When any of the above solvents (without or with acid included) were mixed with water yielding 5.7 wt-% of water, mimicking the addition of 15% MnTACN-SO₄ solution to the solvent, a poor stability of the PVOH film was observed.

Therefore, the MnTACN salt cannot be dosed as an aqueous solution (which is the solvent used to prepare the MnTACN compound) and as a consequence, no additional dissolution and stability tests were done of the MnTACN salt pre-dissolved in water and then mixed with above-mentioned solvents.
B) Tests demonstrating that water-soluble MnTACN catalysts dissolve in the solvents used in the invention and showed good storage stability, whilst the MnTACN-PF₆ salt shows poor solubility.
B1) Comparative Experiments

Dissolution of MnTACN-PF₆ catalyst in various solvents was performed. First a screening was done in which solvents the PF₆ salt of the MnTACN catalyst could be dissolved.

This compound was well soluble in formic acid, but turned brown. It could also be dissolved in ethylene glycol after heating. Finally, MnTACN-PF₆ dissolved very well in acetonitrile.

Poor solubility (solvent remained colourless) was observed in 1,3-propanol-diol, 1-hexanol, 1-propanol, 2-ethyl-1-hexanol, 2-propanol, dipropylene glycol, Dowanol PM, Dowanol DPM, ethanol (abs) and ethyl acetate.

These results indicate that the PF₆ salt can only be dissolved in a selected set of solvents, often those that would be incompatible to be used in consumer products for toxicity reasons (like acetonitrile) or a poor stability was observed (like formic acid). The only relevant solvent identified was ethylene glycol, which showed, however, a poor compatibility with the PVOH film. All the other solvents tested and used according to the invention were unsuitable to dissolve MnTACN-PF₆.
B2) Next MnTACN-SO₄ was tested in various solvents.
   In dipropylene glycol good solubility and stability was observed.
   The same was found in the presence of 3 wt % citric acid.
   However, in the presence of 3 wt % sulfuric acid and 3 wt % of nitric acid, a precipitation was observed after 2 weeks of storage.
   In Dowanol PM without or with 3 wt % citric acid, a good solubility and stability was observed. With sulfuric acid or nitric acid, a poor solubility was observed.
   In propylene glycol a good solubility and stability was observed (no tests were done with acids added).

So these results show that MnTACN-SO₄ can be dissolved and remains stable in more solvents (or in combinations with acids) than MnTACN-PFs.
B3) Next MnTACN-NO₃ was tested in various solvents.
   In dipropylene glycol good solubility and stability was observed. The same was found in the presence of 3 wt % sulfuric acid and 3 wt % of nitric acid.
   In Dowanol PM without or with 3 wt % citric acid or 3 wt % sulfuric acid, a good solubility and stability was observed.
   In propylene glycol a good solubility and stability was observed (no tests were done with acids added).

So these results show that MnTACN-NO₃ can be dissolved and remains stable in more solvents (or in combinations with acids) than MnTACN-PF₆.
B4) Finally, some other water-soluble MnTACN salts were tested for dissolution and 4 weeks in dipropylene glycol. Also the MnTACN-tosylate and MnTACN-Cl₂ dissolved in this solvent, albeit that the chloride salt had to be heated. The latter was a bit brownish of appearance likely due to the use of a less pure sample.

MnTACN-benzoate also dissolved well in dipropylene glycol and shows a very high stability upon storage (room temperature for at least 7 months).
C. Dishwash machine tea-stain cleaning experiments.

A standard dishwash machine tablet was prepared using the same ingredients as disclosed in WO2022/058039 (Weylchem Performance Products GmbH). Together with each tablet (14 g) on top, either no catalyst was added (blank), 100 mg of Weylclean® FDO X (uncoated granules containing 2 wt-% of MnTACN-PF₆ (comparative)) was added, or 82 mg of dipropylene glycol containing 1.64 mg of dissolved MnTACN-SO₄ (Exp low MnTACN-SO₄) or 100 mg of dipropylene glycol containing 2 mg of dissolved MnTACN-SO₄ (Exp high MnTACN-SO₄).

The cleaning tests showed the following results of tea-stain cleaning on tea cups (0 means no cleaning, 100 means complete removal of tea stains):
Blank: 55 points
Comparative: 72 points
Exp low MnTACN-SO₄: 80 points
Exp high MnTACN-SO₄: 85 points

These results show that the dissolved MnTACN-SO₄ in dipropylene glycol give a better cleaning of the tea stains than the MnTACN-PF₆-based granules, both on a basis of equimolar level (Exp low MnTACN-SO₄), as well as on a basis of equal weight of MnTACN-SO₄ vs MnTACN-PF₆ (Exp high MnTACN-SO₄).

These results are particularly surprising as the anion of the MnTACN complex does not alter the bleaching activity (or enhancement of hydrogen peroxide). So therefore, these results show that the dissolution of MnTACN-PF₆ (dosed as a granule) is probably less optimal than for the predissolved MnTACN-SO₄ catalyst in dipropylene glycol.

1. A liquid composition containing a solvent selected from the group consisting of mono aliphatic alcohols having between two and six carbon atoms, mono-, di-, tri- or tetraalkylene glycols having between two, and four carbon atoms in the alkylene moiety, cyclohexanol, benzyl alcohol and glycerol, whereby each OH group is independently, substituted by an OR group, whereby R is alkyl with 1 to 4 carbon atoms, and whereby the solvent contains 0.01-10 wt-% of an inorganic or organic acid, and dissolved therein a mononuclear or dinuclear Mn(III) or Mn(IV) complex salt having a non-coordinating counter ion selected from the group consisting of halides, nitrate, nitrite, thiocyanate, cyanate cyanide, sulfate, hydrogen sulfate, sulfate monoester, sulfonates, monocarboxylates, dicarboxylates and dicarboxylate monoesters, and having a water-solubility of at least 30 g/L at 20° C., and wherein the mononuclear or dinuclear Mn(III) or Mn(IV) complex comprises at least one ligand of formula (I) 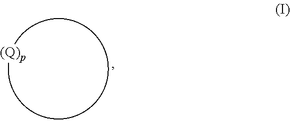
wherein: 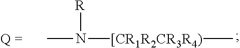
p is 3;
R is independently selected from the group consisting of hydrogen, C₁-C₂₄ alkyl, CH₂CH₂OH and CH₂COOH; or one R is linked to the nitrogen atom of another Q of another ring of formula (I) via a C₂-C₆ alkylene bridge, a C₆-C₁₀ arylene bridge or a bridge comprising between one and two C₁-C₃ alkylene units and one C₆-C₁₀ arylene unit, which bridge is substituted with C₁-C₂₄ alkyl groups; and
R₁, R₂, R₃, and R₄ are independently selected from H, C₁-C₄alkyl and C₁-C₄-alkylhydroxy.

2. The composition of claim 1, wherein the solvent is selected from the group consisting of mono aliphatic alcohols having three to six carbon atoms, mono alkylene glycols having three or four carbon atoms in the alkylene moiety, di-, tri- or tetraalkylene glycols having between two and four carbon atoms in the alkylene moiety, cyclohexanol, benzyl alcohol and glycerol, whereby each OH group is independently, substituted by a OR group, whereby R is alkyl with 1 to 4 carbon atoms.

3. The composition of claim 2, wherein the solvent is selected from the group consisting of mono alkylene glycols having between three and four carbon atoms in the alkylene moiety, and di-, tri- or tetraalkylene glycols having between two, and four carbon atoms in the alkylene moiety, whereby each glycol OH group is independently substituted by a OR group, whereby R is alkyl with 1 to 4 carbon atoms, with the proviso that the solvent is not ethylene glycol.

4. The composition claim 1, wherein the ligand of formula (I) is selected from 1,4,7-trimethyl-1,4,7-triazacyclononane (Me₃-TACN) and 1,2-bis(4,7-dimethyl-1,4,7-triazacyclonan-1-yl)ethane (Me₄-DTNE).

5. The composition of claim 1, wherein the non-coordinating counter ion is an anion selected from the group consisting of Cl⁻, Br⁻, I⁻, NO₃⁻, ClO₄⁻, OCN⁻, SCN⁻, SO₄²⁻, HSO₄⁻, R′SO₄⁻, R′COO⁻, R″ oxalate-, oxalate²⁻, CF₃SO₃⁻ and R′SO₃⁻, whereby R′ is selected from hydrogen, C₁-C₄ alkyl and methyl substituted phenyl, whereby R″ is selected from H, Na, K and Li and R″ oxalate⁻ is a mono-charged counterion, whereby R″ is selected from hydrogen, hydrogen oxalate, or an alkali metal ion selected from Li⁺, Na⁺ and K⁺.

6. The composition according to claim 5, wherein the non-coordinating counter ion is selected from the group consisting of NO₃⁻, SO₄²⁻, HSO₄⁻, Cl⁻, acetate, tosylate and benzoate.

7. The composition according to claim 1, wherein the non-coordinating counter ion having a water-solubility of at least 30 g/L at 20° C. is a water-soluble transition metal ion-containing bleaching catalyst selected from the group consisting of [Mn^{IV}₂(μ-O)₃(Me₃TACN)₂]SO₄, [Mn^{IV}₂(μ-O)₃(Me₃TACN)₂](NO₃)₂, [Mn^{IV}₂(μ-O)₃(Me₃TACN)₂](tosylate)₂, [Mn^{III}Mn^{IV}(μ-O)₂(μ-CH₃COO)(Me₄DTNE)]—SO₄, [Mn^{III}Mn^{IV}(μ-O)₂(μ-CH₃COO) (Me₄DTNE)](NO₃)₂, [Mn^{III}Mn^{IV}(μ-O)₂(μ-CH₃COO) (Me₄DTNE)]Cl₂ and [Mn^{IV}₂(μ-O)₃(Me₃TACN)₂]Cl₂.

8. The composition according to claim 7, wherein the water-soluble transition metal ion-containing bleaching catalyst is selected from the group consisting of [Mn^{IV}₂(μ-O)₃(Me₃TACN)₂]SO₄, [Mn^{IV}₂(μ-O)₃(Me₃TACN)₂](NO₃)₂ and [Mn^{IV}₂(μ-O)₃(Me₃TACN)₂](tosylate)₂.

9. The composition according to claim 1, wherein the solvent is selected from propylene glycol, butylene glycol, di-ethylene glycol, di-propylene glycol, di-butylene glycol, tri-ethylene glycol, tri-propylene glycol, tri-butylene glycol, tetra-ethylene glycol, whereby each glycol OH group is substituted by an OR group, whereby R is alkyl with 1 to 4 carbon atoms.

10. The composition according to claim 9, wherein R is methyl.

11. The composition of claim 9, wherein propylene is selected from 1,2-propylene and 1,3-propylene and wherein butylene is selected from 1,2-butylene, 1,3-butylene and 1,4-butylene.

12. The composition according to claim 1, wherein the solvent is selected from the group consisting of propylene glycol, diethylene glycol, triethylene glycol, dipropylene glycol, tripropylene glycol, propylene glycol monomethyl ether, and dipropylene glycol methyl ether.

13. The composition of claim 12, wherein the solvent is selected from propylene glycol, propylene glycol monomethyl ether, and dipropylene glycol methyl ether.

14. The composition according to claim 1, wherein the acid is selected from the group consisting of sulfuric acid, nitric acid and citric acid.

15. The composition according to claim 1, wherein the amount of mono-nuclear or dinuclear Mn(III) and/or Mn(IV) complex is between 0.1 and 5 wt-% referring to the total amount of complex and solvent.

16. A bleaching formulation comprising the composition of claim 1 and a peroxy compound.

17. A cleaning agent comprising the composition of claim 1.

18. The cleaning agent of claim 17 comprising a dishwashing agent.

19. The composition according to claim 1 wherein the OH group of the solvent is not substituted, the solvent does not contain an acid group, and there are both Mn(III) and Mn(IV) ions present in the complex salt.

20. A liquid composition containing a solvent selected from the group consisting of an ether of mono aliphatic alcohols having between two and six carbon atoms, mono-, di-, tri- or tetraalkylene glycols having between two, and four carbon atoms in the alkylene moiety, cyclohexanol, benzyl alcohol or glycerol, whereby one or more OH groups of said mono aliphatic alcohols, glycols, cyclohexanol, benzyl alcohol or glycerol are replaced by an OR group, whereby R is alkyl with 1 to 4 carbon atoms, and whereby the solvent contains 0-10 wt-% of an inorganic or organic acid, and dissolved therein a mononuclear or dinuclear Mn(III) or Mn(IV) complex salt having a non-coordinating counter ion selected from the group consisting of halides, nitrate, nitrite, thiocyanate, cyanate cyanide, sulfate, hydrogen sulfate, sulfate monoester, sulfonates, monocarboxylates, dicarboxylates and dicarboxylate monoesters, and having a water-solubility of at least 30 g/L at 20° C., and wherein the mononuclear or dinuclear Mn(III) or Mn(IV) complex comprises at least one ligand of formula (I) 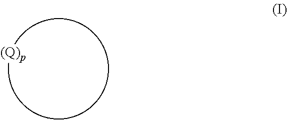
wherein: 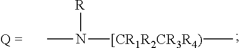
p is 3;
R is independently selected from the group consisting of hydrogen, C₁-C₂₄ alkyl, CH₂CH₂OH and CH₂COOH; or one R is linked to the nitrogen atom of another Q of another ring of formula (I) via a C₂-C₆ alkylene bridge, a C₆-C₁₀ arylene bridge or a bridge comprising between one and two C₁-C₃ alkylene units and one C₆-C₁₀ arylene unit, which bridge is substituted with zero or more C₁-C₂₄ alkyl groups; and R₁, R₂, R₃, and R₄ are independently selected from H, C₁-C₄alkyl and C₁-C₄-alkylhydroxy.

21. The composition of claim 2, wherein the solvent is selected from the group consisting of an ether of said mono aliphatic alcohols, alkylene glycols, cyclohexanol, benzyl alcohol or glycerol whereby one or more OH groups of said mono aliphatic alcohols, alkylene glycols, cyclohexanol, benzyl alcohol or glycerol are replaced by a OR group, whereby R is alkyl with 1 to 4 carbon atoms.

22. The composition of claim 3, wherein the solvent is from the group consisting of an ether of said mono alkylene glycols, di-, tri- or tetraalkylene glycols whereby one or more OH groups of said mono alkylene glycols, di-, tri- or tetraalkylene glycols are replaced by a OR group, whereby R is alkyl with 1 to 4 carbon atoms, with the proviso that the solvent is not ethylene glycol.

23. The composition according to claim 9 wherein the solvent is selected from the group consisting of an ether of propylene glycol, butylene glycol, di-ethylene glycol, di-propylene glycol, di-butylene glycol, tri-ethylene glycol, tri-propylene glycol, tri-butylene glycol, tetra-ethylene glycol, whereby one or more OH groups of said propylene glycol, butylene glycol, di-ethylene glycol, di-propylene glycol, di-butylene glycol, tri-ethylene glycol, tri-propylene glycol, tri-butylene glycol, tetra-ethylene glycol, are replaced by an OR group, whereby R is alkyl with 1 to 4 carbon atoms.
